(19) United States
(12) Patent Application Publication
(10) Pub. No.: US 2003/0070354 A1
(43) Pub. Date: Apr. 17, 2003

(54) Plant package having a waxy layer and a decorative printed pattern

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/298,014

(22) Filed: Nov. 14, 2002

Related U.S. Application Data
(63) Continuation of application No. 09/736,747, filed on Dec. 14, 2000.
Application No. 09/736,747 is a continuation-in-part of application No. 09/076,231, filed on May 12, 1998, now abandoned.
Application No. 09/076,231 is a continuation of application No. 08/717,791, filed on Sep. 23, 1996, now abandoned.
Application No. 08/717,791 is a continuation-in-part of application No. 08/438,818, filed on May 11, 1995, now Pat. No. 5,557,882.
Application No. 08/438,818 is a continuation-in-part of application No. 07/923,202, filed on Oct. 13, 1992, now Pat. No. 5,596,862.

(51) Int. Cl. A01G 5/00; A47G 7/00

(52) U.S. Cl. 47/41.01

(57) ABSTRACT

A method of wrapping a floral grouping or flower pot with a laminated sheet of material made up of at least a waxy layer and a support layer which are connected or laminated to each other. A second waxy layer may be connected or laminated to the other surface of the support surface. The waxy layer is made from a waxy material such as waxed paper, waxed tissue or high density polyethylene. The laminated sheet of material is provided with a substantially undistorted printed pattern disposed thereon. When the laminated sheet of material is utilized to wrap a floral grouping, the wrapped floral grouping may also contain a shredded material for cushioning the blooms of the floral grouping.

### CROSS-REFERENCE TO RELATED APPLICATIONS

The present application is a continuation of U.S. Ser. No. 09/736,747, filed Dec. 14, 2000, now abandoned; which is a continuation-in-part of U.S. Ser. No. 09/076,231 filed May 12, 1998, now abandoned; which is a continuation of U.S. Ser. No. 08/717,791 filed Sep. 23, 1996, now abandoned; which is a continuation-in-part of U.S. Ser. No. 08/438,818, filed May 11, 1995, now U.S. Pat. No. 5,557,882, issued Sep. 24, 1996; which is a continuation-in-part of U.S. Ser. No. 07/923,202, filed Oct. 13, 1992, now U.S. Pat. No. 5,596,862, issued Jan. 28, 1997, the contents of which are all expressly incorporated herein by reference in their entirety.

### STATEMENT REGARDING FEDERALLY SPONSORED RESEARCH OF DEVELOPMENT

Not Applicable

### BACKGROUND

The present invention relates to methods of wrappings floral grouping and potted plants with a wrapper and disposing floral groupings and potted plants within a decorative cover, in particular, but not limited to, wherein the wrapper or decorative cover comprises a waxy material and has a decorative pattern printed thereon.

In the floral industry, when wrapping orchids for packing or shipment it is customary to use a waxy material such as a waxed paper or waxed tissue paper. The wrapping must be delicate so that it does not bruise or otherwise damage the delicate orchids. However, waxed tissue paper tends to compress in the package. When compressed in such a way, the waxed tissue paper loses its cushioning effect and thus does not function effectively to protect the orchids.

A wrapping material which is relatively stiff while retaining the soft, cushioning effect of waxy material would be desirable for use in wrapping and packaging orchids and other floral types.

### BRIEF DESCRIPTION OF THE DRAWINGS

FIG. 1 is a perspective view of a laminated sheet of material constructed in accordance with the present invention and having one corner thereof upwardly turned.

FIG. 2 is an exaggerated cross-sectional view of the laminated sheet of material of FIG. 1.

FIG. 3 is a perspective view of a sheet of material constructed in accordance with the present invention and having a floral grouping disposed thereon.

FIG. 4 is a perspective view of the floral grouping and sheet of material of FIG. 3 wherein the sheet of material is being wrapped about the floral grouping by one method of wrapping.

FIG. 5 is a perspective view of the floral grouping and sheet of material of FIGS. 3 and 4 wherein the sheet of material is wrapped in a conical fashion about the floral grouping.

FIG. 6 is a perspective view of the sheet of material of FIG. 3 wrapped about the floral grouping in a cylindrical fashion.

FIG. 7 is a perspective view of a potted plant such as may be wrapped by the method of the present invention.

FIG. 8 is a perspective view of a potted plant wrapped with a sheet of material in accordance with the present invention.

FIG. 9A is a perspective view of a floral sleeve constructed in accordance with the present invention.

FIG. 9B is a perspective view of another embodiment of a floral sleeve constructed in accordance with the present invention.

FIG. 10 is a perspective view of the sleeve of FIG. 9A disposed about a floral grouping.

FIG. 11 is a perspective view of another embodiment of a sleeve constructed in accordance with the present invention, the sleeve having a cinching element.

FIG. 12 is a perspective view of the sleeve of FIG. 11 disposed about a floral grouping.

FIG. 13 is an elevational view of another embodiment of a sleeve constructed in accordance with the present invention, the sleeve having a detaching element for separating an upper portion thereof.

FIG. 14 is a perspective view of the sleeve of FIG. 13 having a potted plant disposed therein.

FIG. 15 is a perspective view of the potted plant disposed in the sleeve of FIG. 14 after an upper portion of the sleeve has been removed to provide a decorative flower pot cover having a skirt.

FIG. 16 is a perspective view of a preformed flower pot cover constructed in accordance with the present invention.

FIG. 17 is a perspective view of the preformed flower pot cover of FIG. 16 having a flower pot disposed therein.

FIG. 18 is a perspective view of a sheet of material constructed in accordance with the present invention and having a shredded material and floral grouping disposed thereon.

FIG. 19 is a perspective view of the sheet of material and floral grouping of FIG. 18 wherein the sheet of material is conically wrapped about the floral grouping.

FIG. 20 is a perspective view of a floral grouping and shredded material disposed within the sleeve of FIG. 9A.

### DETAILED DESCRIPTION OF THE INVENTION

The present invention comprises methods of wrapping a floral grouping or potted plant. The method comprises providing the floral grouping or potted plant, providing a wrapper made from a sheet of material having a waxy or waterproof material laminated to one or both sides thereof and placing the wrapper about the floral grouping or potted plant, thereby forming a wrapped floral grouping or potted plant, respectively. The wrapper may be a laminated sheet of material or a sleeve or a preformed flower pot cover made from the sheet of laminated material, and the sheet of material is provided with a decorative printed pattern disposed thereon such that the decorative printed pattern is visible on an exposed surface of the wrapper. The wrapper may further be defined as having a portion which is detachable via a detaching element such as perforations. The wrapper may have a bonding material disposed thereon for bondingly holding the wrapper about the floral grouping or flower pot.

The sheet of material (or other wrapper such as a sleeve or preformed flower pot cover) functions to substantially prevent or minimize such damage by being less compressible when wrapped about a floral grouping than would be a wrapper made only from the sheet of waxy material used in forming the wrapper herein described. In other words, the wrapper claimed herein retains the benefits of a waxy wrapping material while adding the degree of stiffness necessary to reduce the chances that the wrapper will be excessively compressed against the floral grouping, thereby causing damage to the floral grouping and especially to a bloom portion of the floral grouping.

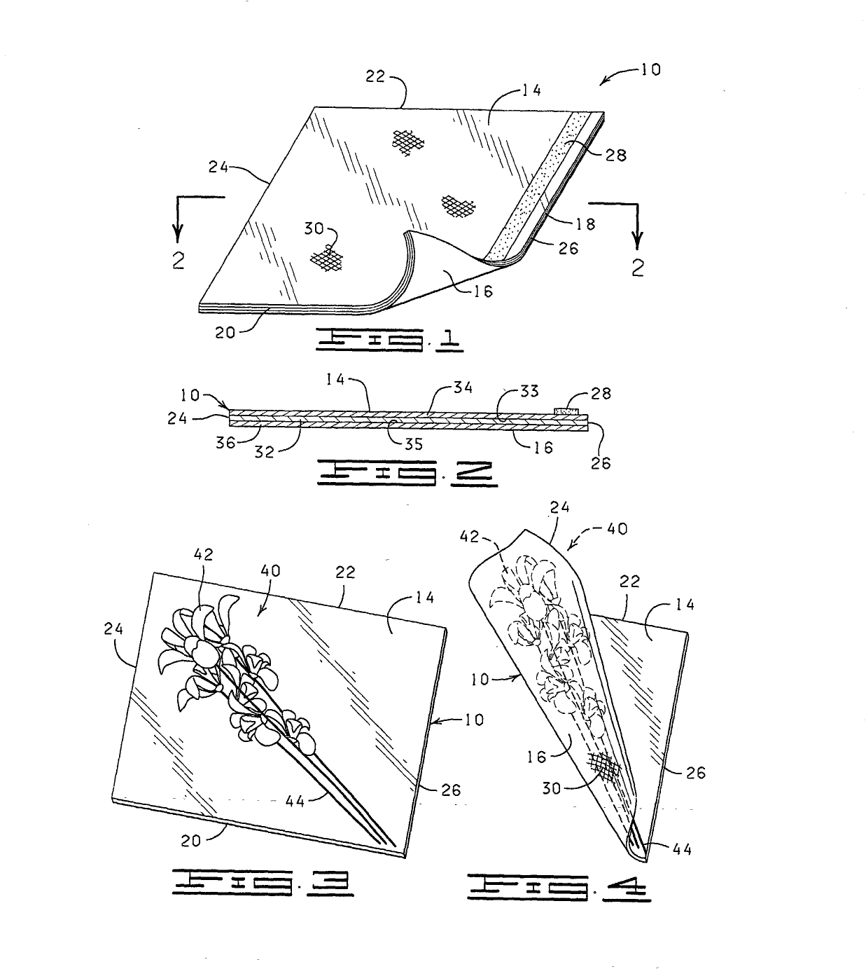

### Description of FIGS. 1-8

Referring now to FIGS. 1 and 2, designated generally by the reference numeral 10 is a laminated sheet of material 12 constructed in accordance with the present invention and which may be utilized to form a wrapper for a floral grouping or flower pot. The laminated sheet of material 10 has an upper surface 14, a lower surface 16, and an outer peripheral edge 18 (one corner of of the laminated sheet of material 10 being lifted for illustration purposes only). As shown in FIG. 1, the outer peripheral edge 18 of the laminated sheet of material 10 comprises a first side 20, a second side 22, a third side 24, and fourth side 26. The laminated sheet of material 10 may include a bonding material 28 disposed on at least a portion of the upper surface 14 and/or the lower surface 16 thereof, as is illustrated for example in U.S. Pat. No. 5,181,364, entitled “Wrapping A Floral Grouping With Sheets Having Adhesive or Cohesive Material Applied Thereto”, issued to Weder on Jan. 26, 1993, the specification of which is hereby expressly incorporated herein by reference. The laminated sheet of material 10 is further provided with a substantially undistorted decorative printed pattern 30 disposed on at least a portion of at least one of the upper surface 14 and the lower surface 16 thereof. The substantially undistorted decorative printed pattern 30 may be any shape, design, or form, including any geometric form or combination of geometric forms, such as squares, round spots, triangles, rectangles, octagonals, or the like, or any non-geometric, asymmetrical or fanciful forms or any combination thereof, including hearts, balloons, flowers, lace, slogans, logos, print (any combination of letters and/or numbers), signs, human forms (real and fictional), animal forms (real and fictional), cartoon characters, works of art, musical scores and/or plant and floral shapes generally associated with botanical items such as leaves, petals, stems, roots, fruits and any other biomorphic shapes. The substantially undistorted decorative pattern 30 may include a single color or a plurality of colors.

As noted above, the laminated sheet of material 10 can be utilized to wrap a floral grouping or a flower pot. The term “flower pot” refers to any type of container used for holding a floral grouping or a plant. Examples of flower pots used in accordance with the present invention include, but are not limited to, clay pots, wooden pots, plastic pots, flower pots made from natural and/or synthetic fibers, or any combination thereof. The flower pot is adapted to receive a floral grouping in the retaining space of the flower pot. The floral grouping may be disposed within the flower pot along with a suitable growing medium described in further detail below, or other retaining medium, such as a floral foam. It will also be understood that in some cases the floral grouping, and any appropriate growing medium or other retaining medium, may be disposed in a sleeve without a flower pot if the sleeve is adapted to contain a medium.

“Floral grouping” as used herein refers to cut fresh flowers (and in particular, orchids), artificial flowers, a single flower or other fresh and/or artificial plants or other floral materials and may include other secondary plants and/or ornamentation or artificial or natural materials which add to the aesthetics of the overall floral grouping. Further, the floral grouping may comprise a growing potted plant having a root portion as well. However, it will be appreciated that the floral grouping may consist of only a single bloom or only foliage, or a botanical item (not shown), or a propagule. The term “floral grouping” may be used interchangeably herein with the term “floral arrangement”. The term “floral grouping” may also be used interchangeably herein with the terms “botanical item” and “propagule.”

The term “growing medium” when used herein includes any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

The term “botanical item” when used herein refers to a natural or artificial herbaceous or woody plant, taken singly or in combination. The term “botanical item” also refers to any portion or portions of natural or artificial herbaceous or woody plants including stems, leaves, flowers, blossoms, buds, blooms, cones, or roots, taken singly or in combination, or in groupings of such portions such as a bouquet or floral grouping.

The term “propagule” when used herein refers to any structure capable of being propagated or acting as an agent of reproduction including seeds, shoots, stems, runners, tubers, plants, leaves, roots or spores.

The laminated sheet of material 10 is shown in FIG. 1 as having a square configuration. It will be appreciated, however, that any shape or size of laminated sheet of material 10 may be used to wrap a flower pot or a floral grouping as long as it is sufficiently sized and shaped to wrap and encompass the flower pot or floral grouping. For example, the laminated sheet of material 10 may also comprise other shapes, such as rectangular, round, oval, octagonal, asymmetrical, or the like. In addition, multiple laminated sheets of material 10 may be used in a single circumstance to wrap a flower pot or floral grouping. Moreover, when multiple laminated sheets of material 10 are used in combination, the laminated sheets of material 10 need not be uniform in size or shape. Finally, it will be appreciated that the laminated sheet of material 10 shown in all embodiments herein is generally flattened.

As mentioned above, and shown in FIGS. 1 and 2, the laminated sheet of material 10 is constructed of an inner support layer or sheet of material 32 having an upper surface 33 to which a first layer or sheet of a waxy material 34 has been laminated or otherwise connected and having a lower surface 35 to which a second layer or sheet of a waxy material 36 has been laminated or otherwise connected. The first and second layers of waxy material 34 and 36 may be the same or different types of waxy material. Preferably the inner support layer of material 32 is constructed from paper, metal foil, polymeric film, fabric, cardboard, or laminations or combinations thereof. The inner support layer of material 32 may be comprised of two or more layers of material. It will also be understood that the laminated sheet of material 10 may be formed with only a single layer of the waxy material, such as the first layer of waxy material 34, and the second layer of waxy material 36 may be omitted or formed of a different material.

The waxy material may be a waxed paper, a waxed tissue or any waxed flexible material having cushioning properties. The waxy material may be a natural or synthetic polymeric film material having a surface with a waxy feel which provides a cushioning effect similar to the cushioning effect of a waxed paper or waxed tissue. The waxy material may be any material which provides the beneficial cushioning effects of a waxed material and which has a waxy feel or properties similar to the feel and properties of a substrate having a waxed surface. The waxy material may be a waterproof material which has the cushioning properties of a waxed paper or tissue. Such a waterproof waxy material would repel water, thereby maintaining the cushioning effect of the material. Examples of such polymeric films having a waxy feel which may be utilized as the first and second layers of waxy material 34 and 36 are a high density polyethylene film and a polyvinylchloride film such as are commercially available from Georgia-Pacific Corporation and Minipak of Columbia, South America, respectively.

The substantially undistorted decorative printed pattern 30 may be applied to the upper surface 33 or the lower surface 35 of the inner support layer of material 32 prior to lamination of the first or second layers of waxy material 34 or 36 thereto so that the substantially undistorted decorative printed pattern 30 is “sandwiched” between the two layers, thereby preventing distortion thereto. When only one layer of waxy material is utilized, such as the first layer of waxy material 34 laminated to the upper surface 33 of the inner support layer of material 32, the decorative printed pattern 30 may be applied to the non-laminated surface of the inner support layer of material 32, such as the lower surface 35 thereof. When the inner support layer of material 32 is translucent or transparent, the substantially undistorted printed pattern 30 will be visible through the layer of waxy material 34 if the layer of waxy material 34 is also translucent or transparent. Optionally, the substantially undistorted decorative printed pattern 30 may be applied directly to one or both of the layers of waxy material 34 and 36. Depending on the type of waxy material utilized, the ink applied to the layer of waxy material 34 and/or 36 may tend to smear or bleed, thereby distorting any pattern printed thereon. Therefore, a lacquer may be applied to a surface of the layer of waxy material 34 and/36 prior to disposition of the decorative printed pattern 30 thereon to prevent distortion of the decorative printed pattern 30. Alternatively, inks containing pigment and an effective amount of at least one anti-bleeding agent may be applied to the layer of waxy material 34 and/or 36 to provide the laminated sheet of material 10 with the substantially undistorted decorative printed pattern 30. Regardless of which method described herein above is utilized, a waxy material having a substantially undistorted decorative printed pattern is formed, thereby overcoming the disadvantages and defects of the prior art of printing on waxed paper, and the substantially undistorted decorative printed pattern is visible on an exposed surface of a wrapper or sleeve formed from the laminated sheet of material 10.

The term “anti-bleeding agent” as used herein will be understood to include any agent which prevents distortion of the decorative printed pattern 30 and maintains the luster of the decorative printed pattern 30. Such anti-bleeding agents may be compounds commonly incorporated in adhesives, such as sodium silicate, sugar and starch.

Any thickness or stiffness of the laminated sheet of material 10 may be utilized in accordance with the present invention as long as the laminated sheet of material 10 is flexible and may be wrapped about at least a portion of a flower pot or a floral grouping, as described herein. Stiffer sheets may be scored to facilitate their folding. The sheets of material 32, 34 and 36 used to form the laminated sheet of material 10 will generally have thicknesses in a range of from about 0.1 mil to about 30 mil, desirably thicknesses in a range of from about 0.2 mil to about 10 mil, and more desirably the sheets of material 32, 34 and 36 employed to construct the laminated sheet of material 10 are single sheets of material having thicknesses in a range of from about 0.5 mil to about 2.5 mil.

The term “polymer film” when used herein refers to a synthetic polymer such as a polypropylene or a naturally occurring polymer such as cellophane. A polymer film is relatively strong and not as subject to tearing (substantially non-tearable), as might be the case with paper or foil.

The laminated sheet of material 10 may also be constructed, in whole or in part, from a cling material. “Cling Wrap or Material” when used herein means any material which is capable of connecting to the sheet of material and/or itself upon contacting engagement during the wrapping process and is wrappable about an item whereby portions of the cling material contactingly engage and connect to other portions of another material, or, alternatively, itself, for generally securing the material wrapped about at least a portion of the flower pot. This connecting engagement is preferably temporary in that the material may be easily removed, i.e., the cling material “clings” to the flower pot.

The cling material is constructed from polyethylene such as Cling Wrap made by Glad®, First Brands Corporation, Danbury, Conn., and may be treated, if necessary. The thickness of the cling material will, in part, depend upon the size of sleeve and the size of the flower pot in the sleeve, i.e., generally, a larger flower pot may require a thicker and therefore stronger cling material than a smaller flower pot or a floral grouping. The cling material will range in thickness from about 0.1 mil to about 10 mil, desirably from about 0.5 mil to about 2.5 mil and most desirably from about 0.6 mil to about 2 mil. However, any thickness of cling material may be utilized in accordance with the present invention which permits the cling material to function as described herein.

In one embodiment, the laminated sheet of material 10 may be constructed from two polypropylene films. The polypropylene films comprising the laminated sheet of material 10 may be connected together or laminated or may be separate layers.

The laminated sheet of material 10 may vary in color. Further, the laminated sheet of material 10 may comprise other decorative patterns or designs in addition to the substantially undistorted decorative printed pattern 30 which are printed, etched, and/or embossed thereon. In addition, the laminated sheet of material 10 may have various colorings, coatings, flocking and/or metallic finishes applied separately or simultaneously, or the laminated sheet of material 10 may be characterized totally or partially by pearlescent, opaque, translucent, transparent, tinted, iridescent or the like, qualities. Each of the above named characteristics may occur alone or in combination. Moreover, each surface of the laminated sheet of material 10 may vary in the combination of such characteristics. An example of an ink which may be applied to the surface of the material to print such patterns and designs is described in U.S. Pat. No. 5,147,706, entitled “Water Based Ink On Foil And/Or Synthetic Organic Polymer”, issued to Kingman on Sep. 15, 1992, the specification of which is hereby expressly incorporated herein by reference.

The laminated sheet of material 10 has a width extending generally between the first side 20 and the second side 22, respectively, sufficiently sized whereby the laminated sheet of material 10 can be wrapped about and encompass a floral grouping or a flower pot. The laminated sheet of material 10 has a length extending generally between the third side 24 and the fourth side 26, respectively, sufficiently sized whereby the laminated sheet of material 10 extends over a substantial portion of the floral grouping when the laminated sheet of material 10 has been wrapped about the floral grouping in accordance with the present invention, as described in detail herein. The laminated sheet of material 10 may also be wrapped about a flower pot to substantially wrap and cover the flower pot in accordance with the present invention.

FIGS. 3-6 illustrate the use of the laminated sheet of material 10 in wrapping a floral grouping 40. The laminated sheet of material 10 is provided either as an individual sheet or from a pad or roll by any method described herein. Methods and apparatus for dispensing the laminated sheet of material 10 from a pad or roll of material are shown in U.S. Pat. Nos. 5,111,638 and 5,181,364, the specifications of which are hereby incorporated by reference herein.

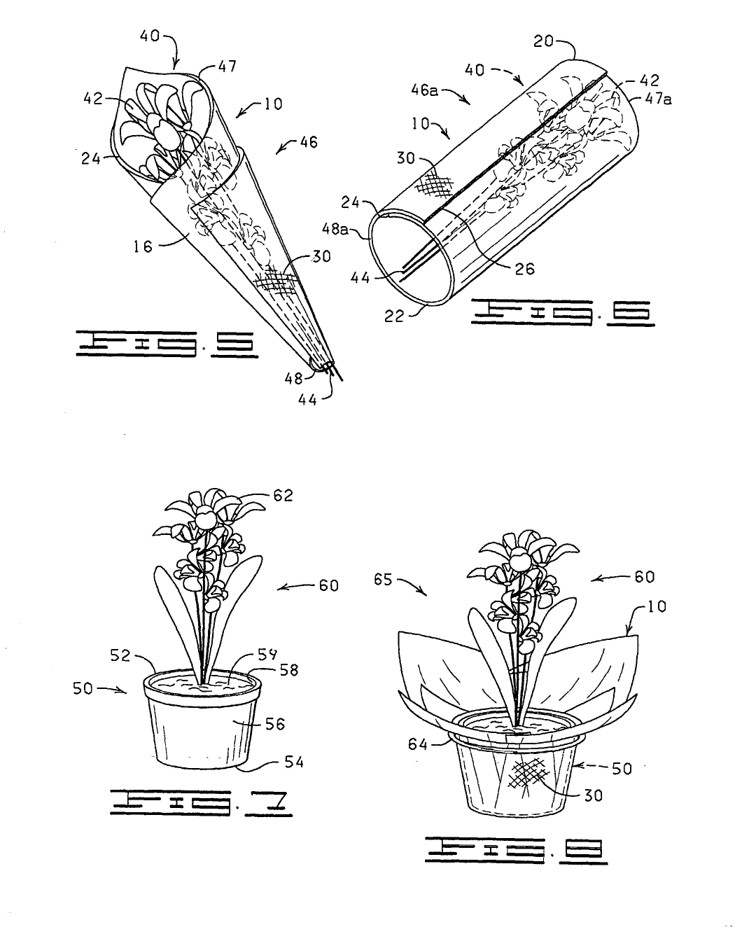

If present, the bonding material 28 may have a backing or release strip. Such backings or release strips are well known to those of ordinary skill in the art. The backing or release strip may be left applied for a period of time to the bonding material 28 after it is disposed on a surface of the laminated sheet of material 10 prior to its use as a wrapping material, to protect the bonding qualities of the bonding strip. In operation, an operator may dispose the laminated sheet of material 10 on a support surface (not shown), the lower surface 16 of the laminated sheet of material 10 contacting the support surface. The floral grouping 40 as shown in FIG. 4 is then provided and disposed upon the upper surface 14 of the laminated sheet of material 10. The floral grouping 40 may be any floral grouping having blooms or flowers but preferably comprises an orchid and generally has an upper end comprising a bloom or foliage portion 42 and a lower end comprising a stem portion 44. The floral grouping 40 may be disposed upon the laminated sheet of material 10 in a diagonal orientation as shown in FIGS. 3-5.

Referring to FIGS. 3 and 4, the laminated sheet of material 10 is then wrapped about the floral grouping 40 by the operator, the operator overlapping a portion of the laminated sheet of material 10 over another portion of the laminated sheet of material 10. That is, for example, the operator places the first side 20 of the laminated sheet of material 10 over the floral grouping 40, as shown in FIGS. 3 and 4. The operator rolls the floral grouping 40 in the direction toward the fourth side 26 until the upper surface 14 near the fourth side 26 firmly engages the lower surface 16 of the laminated sheet of material 10, wherein the floral grouping 40 is substantially encompassed by the laminated sheet of material 10, and wherein the bonding material 28, if present, may contact the laminated sheet of material 10 and/or a portion of the floral grouping 40 to substantially encompass and surround a substantial portion of the floral grouping 40, thereby forming a wrapper 46 for the floral grouping 40. FIG. 5 shows the floral grouping 40 wrapped in a conical fashion with the bloom portion 42 of the floral grouping 40 positioned substantially adjacent an open upper end 47 of the wrapper 46 and the stem portion 44 of the floral grouping 40 positioned substantially adjacent a lower end 48 of the wrapper 46.

Illustrated in FIG. 6 is another embodiment in which the laminated sheet of material 10 is utilized to wrap the floral grouping 40. The floral grouping 40 is disposed upon the laminated sheet of material 10 approximately parallel to the third side 24 of the laminated sheet of material 10. The laminated sheet of material 10 is wrapped generally about the stem portion 44 of the floral grouping 40 to a position wherein the fourth side 26 generally overlaps the third side 24 in a cylindrical fashion. It should be noted that the laminated sheet of material 10 may be wrapped a plurality of times about the stem portion 44 of the floral grouping 40 before the overlapping of the third side 24 and the fourth side 26. As before, the portion of the laminated sheet of material 10 near the fourth side 26 is disposed generally adjacent another portion of the laminated sheet of material 10 and the two adjacent portions then are brought into contact where they may be bondingly engaged, thereby securing the laminated sheet of material 10 generally about the floral grouping 40 and forming a wrapper 46a having an open upper end 47a and an open lower end 48a.

The wrappers 46 and 46a (or any wrapper described elsewhere herein, such as a sleeve) once wrapped about the floral grouping 40 function under ordinary handling conditions to substantially prevent damage to the bloom portion 42 of the floral grouping 40 by crushing. Such damage may be, for example, breakage, bending, or bruising of the petals of the flowers of the bloom portion 42 of the floral grouping 40. By ordinary handling conditions it is meant the manner typically employed in the floral industry to wrap floral groupings for storage, shipping or sale, especially floral groupings traditionally wrapped in waxed paper such as orchids.

In another version of the invention the laminated sheet of material 10 may be used to wrap a flower pot such as a potted plant, which preferably comprises an orchid in bloom. Shown in FIG. 7 is a flower pot designated by the reference numeral 50 and which has an upper end 52, a lower end 54, an outer peripheral surface 56, an inner retaining space 58 within which may be disposed a growing medium 59. The flower pot 50 may contain a botanical item 60 such as a plant, preferably an orchid, which has an upper portion 62 comprising blooms or foliage or both.

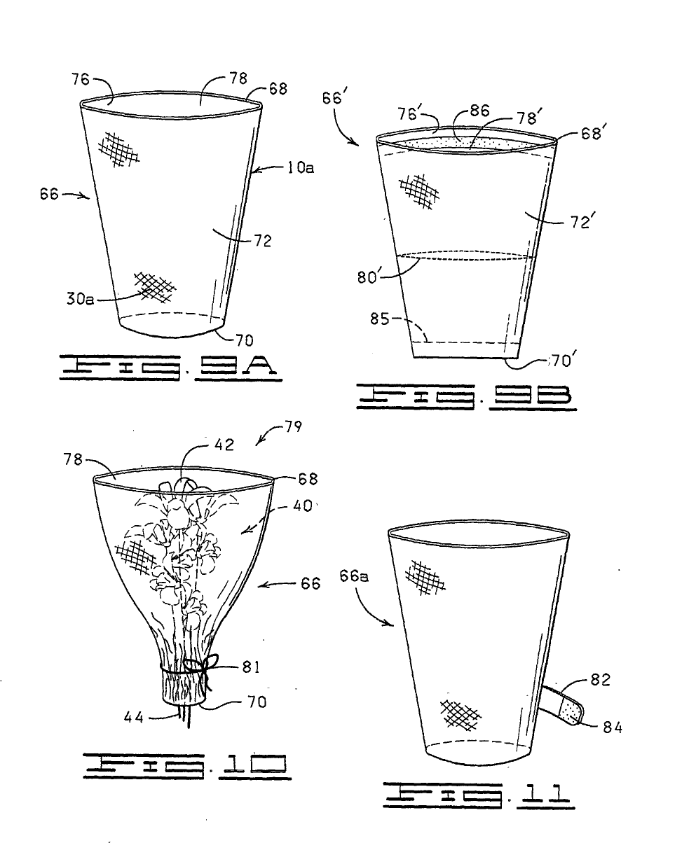

The laminated sheet of material 10 is wrapped about the flower pot 50 to form a decorative cover 65 for the flower pot 50, substantially as shown in FIG. 8. The laminated sheet of material 10 may be wrapped about the flower pot 50 by any one of numerous methods used to wrap sheets of material about flower pots to form decorative flower pot covers. The laminated sheet of material 10 may, for example, be formed by hand about the outer peripheral surface 56 of the flower pot 50 and held thereto. For example, the laminated sheet of material 10 could be held about the flower pot 50 by a bonding material such as described elsewhere herein, or by an elastic band 64 such as shown in FIG. 8. The elastic band 64 could be applied manually or automatically such as by the method shown in U.S. Pat. No. 5,105,599 which is hereby expressly incorporated herein by reference. The elastic band 64 could be applied as a tie using a method such as described in “Single Station Covering and Fastening System”, U.S. Pat. No. 5,609,009, issued to Weder et al on Mar. 11, 1997, the specification of which is hereby expressly incorporated herein by reference. The laminated sheet of material 10 could be applied automatically about the flower pot 50, for example, by methods shown in U.S. Pat. Nos. 4,733,521 and 5,291,721, both of which are hereby expressly incorporated herein by reference.

The term “bonding material” when used herein can include an adhesive, frequently a pressure sensitive adhesive, a cohesive or any adhesive/cohesive combination having adhesive qualities (i.e., qualities of adhesion or adhesion/cohesion, respectively) sufficient to cause the attachment of a portion of the laminated sheet of material 10 to itself, to a portion of a floral grouping, or to a flower pot. It will be appreciated that both adhesives and cohesives are known in the art, and both are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” also includes materials which are sonic sealable and vibratory sealable. The term “bonding material” when used herein also includes a heat sealing lacquer or hot melt material which may be applied to the material and, in this instance, heat, sound waves, or vibrations, also must be applied to effect the sealing.

The term “bonding material” when used herein also includes any type of material or thing which can be used to effect the bonding or connecting of the two adjacent portions of the material or sheet of material to effect the connection or bonding described herein. The term “bonding material” may also include ties, labels, bands, ribbons, strings, tapes (including single or double-sided adhesive tapes), staples or combinations thereof. Some of the bonding materials would secure the ends of the material while other bonding materials may bind the circumference of a wrapper or a sleeve, or, alternatively and/or in addition, the bonding materials would secure overlapping folds in the material and/or sleeve. Another way to secure the wrapper and/or sleeve is to heat seal the ends of the material to another portion of the material. One way to do this is to contact the ends with an iron of sufficient heat to heat seal the material.

Alternatively, a cold seal adhesive may be utilized as the bonding material. The cold seal adhesive adheres only to a similar substrate, acting similarly as a cohesive, and binds only to itself. Since the cold seal adhesive bonds only to a similar substrate, it does not cause a residue to build up on equipment, thereby permitting much more rapid disposition and use of such equipment to form articles and reducing labor costs. Further, since no heat is required to effect the seal, the dwell time, that is, the time for the sheet of material to form and retain the shape of an article such as a flower pot cover or flower pot, is reduced. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method which may weld portions of the material to itself or to the flower pot, or to both the material itself and the flower pot.

### Description of FIGS. 9A-15

Shown in FIG. 9A is a sleeve 66 having unitary construction and constructed in accordance with the present invention. The sleeve 66 may be constructed from a laminated sheet of material 10a substantially similar to the laminated sheet of material 10 described in detail hereinbefore with reference to FIGS. 1 and 2, and a floral grouping 40, a flower pot 50 and/or a plant 60 may be disposed in the sleeve 66. The sleeve 66 initially is provided in a generally flattened, collapsed condition which is openable in the form of a tube or sleeve. Such sleeves and their methods of construction are well known in the floral industry.

The sleeve 66 has an upper end 68, a lower end 70, and an outer peripheral surface 72. The sleeve 66 is open at the upper end 68 thereof and may be open at the lower end 70 thereof, such as is shown in FIG. 9A, or closed with a bottom at the lower end 70, such as is shown in FIG. 9B. The sleeve 66 also has an inner peripheral surface 76 which, when the sleeve 66 is opened, defines and encompasses an inner retaining space 78. The laminated sheet of material 10a from which the sleeve 66 is constructed is provided with a substantially undistorted decorative printed pattern 30a disposed thereon as described hereinbefore with reference to the printed pattern 30 disposed on the laminated sheet of material 10, such that the sleeve 66 is provided with the substantially undistorted decorative printed pattern 30a disposed on at least a portion of the outer peripheral surface 72 thereof. However, it will be understood that the invention is not limited to the substantially undistorted printed pattern 30a being disposed on the outer peripheral surface 72 of the sleeve 66, and if desired, the substantially undistorted printed pattern 30a may be disposed on at least a portion of the inner peripheral surface 76 or a combination of the outer and inner peripheral surfaces 72 and 76 of the sleeve 66.

The sleeve 66 may be tapered outwardly from the lower end 70 toward a larger diameter at the upper end 68 thereof. In its flattened state the sleeve 66 generally has an overall trapezoidal or modified trapezoidal shape, and when opened is substantially frusto-conical to coniform. It will be appreciated, however, that the sleeve 66 may comprise variations on the aforementioned shapes or may comprise significantly altered shapes such as square, rectangular, angular or contoured in shape, wherein the sleeve 66 when opened has a cylindrical or frusto-conical form or a combination of frusto-conical and cylindrical or any other shape, as long as the sleeve 66 functions in accordance with the present invention in the manner described herein. Further, the sleeve 66 may comprise any shape, whether geometric, non-geometric, asymmetrical and/or fanciful as long as it functions in accordance with the present invention. The sleeve 66 may also be equipped with drain holes (if having a closed bottom) or side ventilation holes (not shown), or can be made from gas permeable or impermeable materials.

The material from which the sleeve 66 is constructed is the same as previously described above for the laminated sheet of material 10. Such materials used to construct the sleeve 66 are further described in U.S. Pat. No. 5,111,637, which is hereby expressly incorporated herein by reference. Any thickness of material may be utilized in accordance with the present invention as long as the sleeve 66 may be formed as described herein, and as long as the formed sleeve 66 may contain at least a portion of the flower pot 50, the plant 60 and/or the floral grouping 40, as described herein. Additionally, an insulating material such as bubble film, preferably as one of two or more layers, can be utilized in order to provide additional protection for the item, such as the floral grouping 40, contained therein.

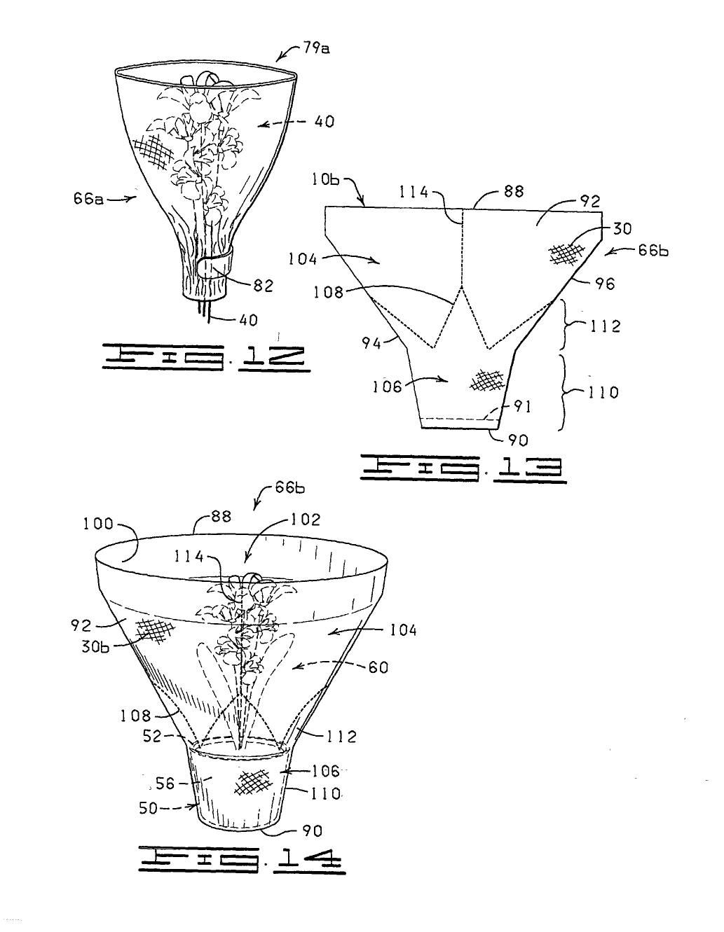

Shown in FIG. 10 is the sleeve 66 having the floral grouping 40 disposed within the inner retaining space 78 thereof, thereby forming a decorative cover 79 for the floral grouping 40. Generally, the bloom portion 42 of the floral grouping 40 is positioned substantially adjacent to the upper end 68 of the sleeve 66 and the stem portion 44 of the floral grouping 40 is positioned substantially adjacent to the lower end 70 of the sleeve 66. Either end of the sleeve 66 may be closed about the floral grouping 40. Generally, a portion of the sleeve 66 is tightened about a portion of the stem portion 44 of the floral grouping 40 for holding the sleeve 66 about the floral grouping 66. For example, the sleeve 66 may be held by a tie 81 tied about the sleeve 66, substantially as shown in FIG. 10.

Other methods for binding the sleeve 66 may be employed such as the bonding materials described elsewhere herein. For example, shown in FIG. 11 is a sleeve 66a which includes a cinching tab 82 having a bonding material 84 disposed upon a surface thereof. The cinching tab 82 can be used to gather portions of the sleeve 66a together about the stem portion 44 of the floral grouping 40 as shown in FIG. 12 for holding the sleeve 66a tightly about the floral grouping 40, thereby forming a decorative cover 79a for the floral grouping 40.

Similarly, it may generally be desired to use a sleeve 66′ (FIG. 9B) as a decorative cover for the flower pot 50. The sleeve 66′ may be provided with an open upper end 68′ and a closed lower end 70′. A portion of the lower end 70′ may be inwardly folded to form one or more gussets 79 for allowing the lower portion of an inner retaining space 78′ of the sleeve 66′ to be expandable, for example, for receiving a circular bottom of the flower pot 50 or growing medium or floral grouping. The sleeve 66′ may further comprise a detaching element 80 such as perforations for enabling the separation of a portion of the sleeve 66′ above the detaching element 80 from a portion of the sleeve 66′ below the detaching element 80.

The flower pot 50 can be deposited into the open sleeve 66′ in a manner well known in the art, such as manually, wherein the sleeve 66′ is opened by hand and the flower pot 50 deposited therein.

As noted above, a bonding material 86 may optionally be disposed on a portion of the sleeve 66′ or any sleeve described herein to assist in holding the sleeve 66′ to the flower pot 50 when the flower pot 50 is disposed within the sleeve 66′ or to assist in closing the upper end 68′ of the sleeve 66′ or adhering the sleeve 66′ to the flower pot 50 after the flower pot 50 has been disposed therein, as will be discussed in further detail below.

It will be understood that the bonding material 86, if present, may be disposed as a strip or block on a surface of the sleeve 66′. The bonding material 86 may also be disposed upon either an outer peripheral surface 72′ or an inner peripheral surface 76′ of the sleeve 66′ (as shown in FIG. 9B), as well as upon the flower pot 50. Further, the bonding material 86 may be disposed as spots of bonding material, or in any other geometric, non-geometric, asymmetric, or fanciful form, and in any pattern including covering either the entire inner peripheral surface 76′ and/or outer peripheral surface 72′ of the sleeve 66′ and/or the flower pot 50. The bonding material 86 may be covered by a cover or release strip which can be removed prior to the use of the sleeve 66′ or flower pot 50. The bonding material 86 can be applied by methods known to those of ordinary skill in their art. One method for disposing a bonding material, in this case an adhesive, is described in U.S. Pat. No. 5,111,637, which is hereby expressly incorporated herein by reference.

As noted above, a bonding material 86 may be disposed on at least a portion of the inner peripheral surface 76′ of the sleeve 66′ (or any other sleeve described herein), or, alternatively, the bonding material 86 may be disposed on the outer peripheral surface 56 of the flower pot 50 contained within the sleeve 66′, while the sleeve 66′ may be free of the bonding material. In a further alternative, the bonding material 86 may be disposed both on at least a portion of the flower pot 50 as well as upon at least a portion of the inner peripheral surface 76′ of the sleeve 66′. In addition, a portion of the bonding material 86 may also be disposed on the outer peripheral surface 72′ of the sleeve 66′ as well. It will be understood that the bonding material 86 may be disposed in a solid section. The bonding material 86 when present is disposed on the sleeve 66′ and/or flower pot 50 by any methods known in the art.

Certain versions of sleeves described herein may be used in combination with a preformed plant cover. For example, a preformed flower pot cover may be applied to the flower pot, then the covered flower pot may be disposed within a sleeve. Examples of sleeves which may be used in this invention are shown in the specification of U.S. Ser. No. 08/237,078 which is hereby incorporated herein by reference in its entirety. Equipment and devices for forming sleeves are commercially available, and well known in the art.

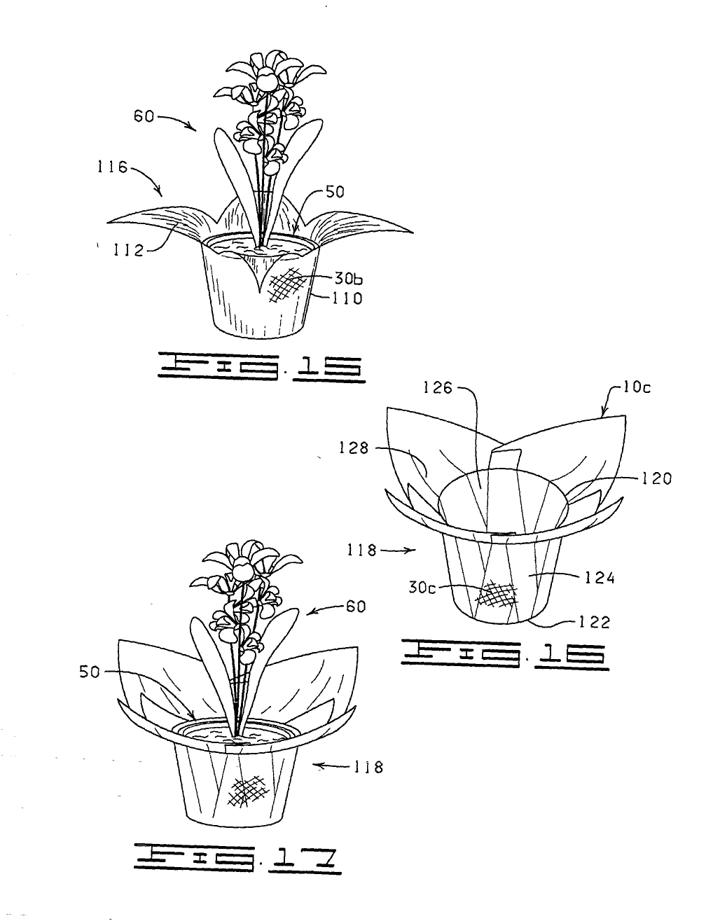

Shown in FIGS. 13 and 14 is a sleeve constructed in accordance with the present invention and designated by the general reference numeral 66b. The sleeve 66b generally is initially provided in a flattened, collapsed condition which is openable in the form of a tube or sleeve. The sleeve 66b is constructed of a laminated sheet of material 10b substantially similar to the laminated sheet of material 10 described herein previously with reference to FIGS. 1 and 2 and is provided with a substantially undistorted decorative printed pattern 30b disposed thereon.

The sleeve 66b has an upper end 88, a lower end 90, an outer peripheral surface 92 and in its flattened state has a first edge 94 and a second edge 96. When opened from the flattened state, the sleeve 66b is open at the upper end 88 thereof, and the lower end 90 may be open or closed. The sleeve 66b also has an inner peripheral surface 100 which, when the sleeve 66b is opened, defines and encompasses an inner retaining space 102 as shown in FIG. 14. When the lower end 90 of the sleeve 66b is closed, a portion of the lower end 90 may be inwardly folded to form one or more gussets 91 (FIG. 13) for permitting a circular bottom of an object such as the flower pot 50 to be disposed into the inner retaining space 102 of the sleeve 66b.

As shown in FIGS. 13 and 14, the sleeve 66b is demarcated into an upper portion 104 and a lower portion 106. The lower portion 106 of the sleeve 66b is generally sized to contain the flower pot 50. The upper portion 104 of the sleeve 66b is sized to substantially surround and encompass the plant 60 contained in the flower pot 50 when the flower pot 50 is disposed within the lower portion 106 of the sleeve 66b. The sleeve 66b is demarcated into the upper portion 104 and the lower portion 106 by a detaching element 108 for enabling the detachment of the upper portion 104 of the sleeve 66b from the lower portion 106 of the sleeve 66b. In the present embodiment, the detaching element 108 is a plurality of generally laterally-oriented, alternatingly diagonally-oriented, curved or linear perforations which extend circumferentially around the outer peripheral surface 92 of the sleeve 66b from the first side 94 to the second side 96 thereof.

In a preferred embodiment, as shown in FIGS. 13 and 14, the lower portion 106 of the sleeve 66b further comprises a base portion 110 and a skirt portion 112. The base portion 110 comprises that part of the lower portion 106 which, when the flower pot 50 is placed into the lower portion 106, is substantially adjacent to and surrounds the outer peripheral surface 56 of the flower pot 50. The skirt portion 112 comprises that part of the lower portion 106 which extends beyond the upper end 52 of the flower pot 50 and adjacent at least a portion of the plant 60 contained within the flower pot 50 and which is left to freely extend at an angle, inwardly or outwardly, from the base portion 110 when the upper portion 104 of the sleeve 66b is detached from the lower portion 106 of the sleeve 66b by actuation of the detaching element 108.

In the intact sleeve 66b, the skirt portion 112 has an upper peripheral edge congruent with the detaching element 108 which is connected to a lower peripheral edge, also congruent with the detaching element 108, of the upper portion 104 of the sleeve 66b. In FIGS. 13 and 14, the upper peripheral edge of the skirt portion 112 is congruent with a series of alternatingly diagonally-oriented lines of perforations which together form a zigzag and comprise the detaching element 108. The upper portion 104 of the sleeve 66b may also have an additional detaching element 114 indicated as a plurality of vertical perforations for facilitating removal of the upper portion 104 and which extend generally between the detaching element 108 and the upper end 88 of the sleeve 66b.

The upper portion 104 of the sleeve 66b is thereby separable from the lower portion 106 of the sleeve 66b by tearing the upper portion 104 along both the detaching element 114 and the detaching element 108, thereby separating the upper portion 104 from the lower portion 106 of the sleeve 66b. The lower portion 106 of the sleeve 66b remains disposed as the base portion 110 about the flower pot 50 and as the skirt portion 112 about a portion of the plant 60, thereby forming a decorative cover 116 as shown in FIG. 15 which substantially surrounds and encompasses the flower pot 50 and a portion of the plant 60 contained therein. In one embodiment of the invention, only the skirt 112 and upper portion 104 of the sleeve may be constructed of the laminate of waxy material, while the base portion is constructed of another material.

The substantially undistorted printed pattern 30b may be disposed on the outer peripheral surface 92 of the sleeve 66b on at least a portion of the upper portion 104 and/or the lower portion 106 thereof. In particular, the substantially undistorted printed pattern 30b may be disposed on the base portion 110 of the lower portion 106 alone, or the skirt portion 112 of the lower portion 106 alone, or the upper portion 104 alone, or on any combination of the upper portion 104, the base portion 110 and the skirt portion 112 of the sleeve 66b.

“Detaching element” as used herein, is not limited to perforations but will be understood to include any element or combination of elements or features such as, but not by way of limitation, perforations, tear strips, zippers, and any other devices or elements of this nature known in the art, or any combination thereof. Therefore, while perforations are shown and described in detail herein, it will be understood that tear strips, tear starts, zippers, or any other “detaching elements” known in the art, or any combination thereof, could be substituted therefor and/or used therewith.

In a general method of use of sleeve 66b as a decorative cover for a flower pot, an operator provides the sleeve 66b and the flower pot 50 having the plant 60 disposed in the growing medium 59 contained within the flower pot 50. The operator then opens the sleeve 66b at the upper end 88 thereof and assures both that the opening therein is in an open condition, and that the inner peripheral surface 100 of the sleeve 66b is somewhat expanded outward as well, as shown in FIG. 14. The operator then manually or automatically disposes the flower pot 50 into the inner retaining space 102 in the sleeve 66b, the flower pot 50 being disposed generally through the upper portion 104 of the sleeve 66b into generally the lower portion 106 of the sleeve 66b, the flower pot 50 remaining in the lower portion 106 of the sleeve 66b, thereby permitting the sleeve 66b to substantially surround and encompass the flower pot 50. The lower portion 106 of the sleeve 66b is positioned substantially adjacent the outer peripheral surface 56 of the flower pot 50, and the upper portion 104 of the sleeve 66b extends upwardly from the flower pot 50 and substantially surrounds and encompasses at least a portion of the plant 60 disposed in the flower pot 50. The upper portion 104 of the sleeve 66b may be detached from the lower portion 106 of the sleeve 66b along the detaching elements 108 and 114 comprising circumferential and vertical perforations, respectively. Upon detachment of the upper portion 106 of the sleeve 66b, the lower portion 106 of the sleeve 66b remains disposed about the outer peripheral surface 56 of the flower pot 50, wherein the base portion 110 of the lower portion 106 is substantially adjacent to and surrounds the outer peripheral surface 56 of the flower pot 50, and the skirt portion 112 of the lower portion 106 extends beyond the upper end 52 of the flower pot 50 and adjacent at least a portion of the plant 60 contained within the flower pot 50.

It will be understood that alternatively, the sleeve 66b may be equipped with holes to facilitate the carrying or support of the sleeve 66b on rods or wickets, and the flower pot 50 then being disposed in the sleeve 66b either before or after the sleeve 66b has been removed from the wickets.

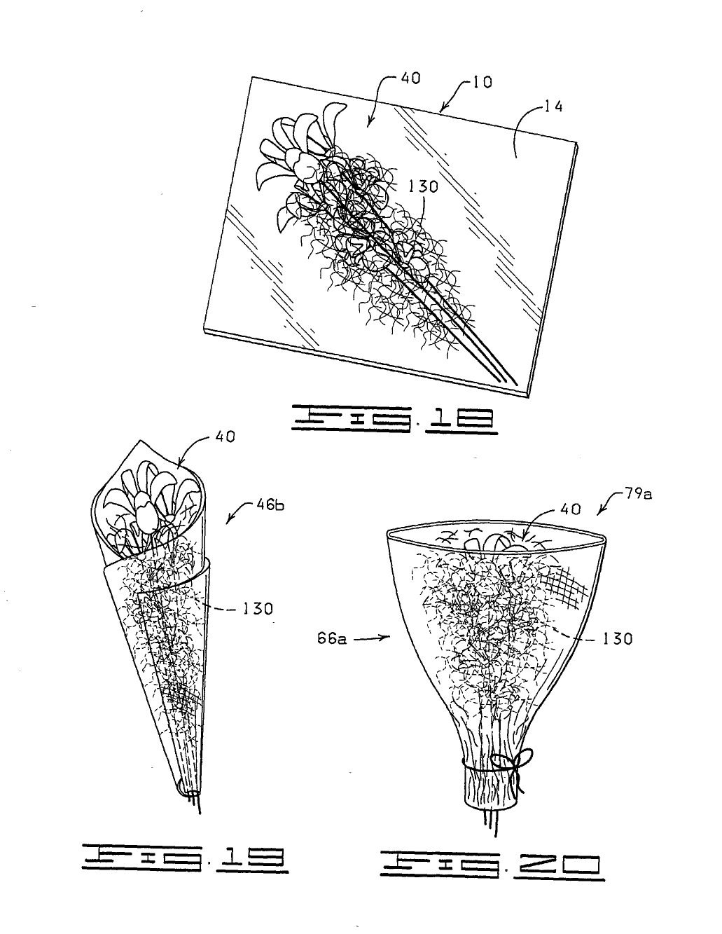

### Description of FIGS. 16 and 17

In another embodiment of the invention, the laminated sheet of material described hereinbefore may be used to form a decorative preformed plant cover 118 which is used to substantially surround and encompass the flower pot 50. Such a decorative preformed flower pot cover 118 is shown in FIG. 16 and is constructed of a laminated sheet of material 10c substantially similar to the laminated sheet of material 10 described hereinbefore and having a decorative printed pattern 30c disposed thereon.

The decorative preformed flower pot cover 118 has an open upper end 120, a closed lower end 122, an outer peripheral surface 124 and an inner peripheral surface 128 which defines and encompasses a retaining space 126 within which the flower pot 50 may be disposed in a manner well known in the art, substantially as shown in FIG. 17.

Methods for forming such preformed decorative flower pot covers are well known in the art. Two methods of forming such covers are described in U.S. Pat. Nos. 4,773,182 and 5,291,721, both of which are hereby expressly incorporated by reference herein.

### Description of FIGS. 18-20

In an alternate embodiment of the invention, the floral grouping 40 may be wrapped with a quantity of a shredded material 130 for providing a cushion when the floral grouping 40 is wrapped with a sheet of material or disposed in a sleeve as described above. The shredded material 130 is preferably formed by shredding the same material as comprises the laminated sheet of material 10. Alternatively, the shredded material 130 may be any shredded material such as paper or polymer film which functions to cushion the floral grouping 40 within the cover. The material may be shredded using shredding methods such as are well known in the art, for example, using a paper shredding device. The shredded material 130 may be placed upon the upper surface 14 of the laminated sheet of material 10 (described herein before with reference to FIGS. 1-5) along with the floral grouping 40, as shown in FIG. 18. The laminated sheet of material 10 is then wrapped about the floral grouping 40 and shredded material 130 in a manner described above to form a decorative wrapper 46b for the floral grouping 40, substantially as shown in FIG. 19.

Alternatively, the shredded material 130 may be placed within the inner retaining space 78 of the sleeve 66 (described hereinbefore with reference to FIGS. 9A and 10) along with the floral grouping 40, and the sleeve 66 is then disposed about the floral grouping 40 and shredded material 130 in a manner disclosed above to form a decorative cover 79a for the floral grouping 40, substantially as shown in FIG. 20.

In each embodiment of the decorative wrappers 46-46a, the decorative covers 79-79a, 65 and 116 and the decorative preformed flower pot cover 118 described herein, the waxy material may be provided on the exposed surface thereof (i.e., an outer peripheral surface thereof), or the waxy material may be disposed on an inner peripheral surface thereof such that the waxy material is substantially adjacent to the flower pot or floral grouping, while the sheet of material connected or laminated to the waxy material may be exposed on an outer peripheral surface thereof.

Changes may be made in the construction and the operation of the various components, elements and assemblies described herein or in the steps or the sequence of steps of the methods described herein without departing from the spirit and scope of the invention as defined in the following claims.

What is claimed is:

1. A laminated sheet of material for wrapping about a flower pot or floral grouping, the laminated sheet of material having an upper surface and a lower surface and comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of a decorative wrapper formed from the laminated sheet of material.

2. The laminated sheet of material of claim 1 wherein the support layer of material has a thickness in a range of from about 0.1 mil to about 30 mil and the layer of waxy material has a thickness in a range of from about 0.1 mil to about 30 mil.

3. The laminated sheet of material of claim 1 further comprising a second layer of waxy material connected or laminated to the unlaminated upper or lower surface of the support layer of material.

4. The laminated sheet of material of claim 1 wherein the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

5. The laminated sheet of material of claim 1 wherein the support layer of material and the layer of waxy material are constructed from transparent or translucent materials.

6. The laminated sheet of material of claim 5 wherein the decorative printed pattern is applied to the unlaminated surface of the support layer of material, and the decorative printed pattern is visible through the layer of waxy material laminated to the other surface of the support layer of material.

7. The laminated sheet of material of claim 1 wherein the decorative printed pattern is applied to the layer of waxy material.

8. The laminated sheet of material of claim 7 wherein a lacquer is applied to a surface of the layer of waxy material prior to disposition of the decorative printed pattern thereon to prevent distortion of the decorative printed pattern.

9. The laminated sheet of material of claim 7 wherein an ink containing a pigment and an effective amount of at least one anti-bleeding agent is utilized to apply the decorative printed pattern to the layer of waxy material to prevent distortion of the decorative printed pattern.

10. The laminated sheet of material of claim 9 wherein the anti-bleeding agent is selected from the group consisting of sodium silicate, sugar and starch.

11. A plant package, comprising:
a floral grouping comprising a bloom portion and a stem portion; and
a decorative wrapper having an upper end and a lower end and substantially encompassing and surrounding a substantial portion of the floral grouping wherein the bloom portion of the floral grouping is positioned substantially adjacent the upper end of the decorative wrapper and the stem portion of the floral grouping is positioned substantially adjacent the lower end of the decorative wrapper, the decorative wrapper formed of a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the decorative wrapper.

12. The plant package of claim 11 wherein the laminated sheet of material from which the decorative wrapper is constructed is provided with a bonding material disposed thereon for securing the laminated sheet of material in a wrapped position about the floral grouping.

13. The plant package of claim 11 wherein the support layer of material of the laminated sheet of material has a thickness in a range of from about 0.1 mil to about 30 mil and the layer of waxy material of the laminated sheet of material has a thickness in a range of from about 0.1 mil to about 30 mil.

14. The plant package of claim 11 wherein the laminated sheet of material from which the decorative wrapper is constructed further comprises a second layer of waxy material connected or laminated to the unlaminated upper or lower surface of the support layer of material.

15. The plant package of claim 11 wherein the decorative printed pattern of the laminated sheet of material is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

16. The plant package of claim 11 wherein the support layer of material of the laminated sheet of material and the layer of waxy material are constructed from transparent or translucent materials.

17. The plant package of claim 16 wherein the decorative printed pattern of the laminated sheet of material is applied to the unlaminated surface of the support layer of material, and the decorative printed pattern is visible through the layer of waxy material laminated to the other surface of the support layer of material.

18. The plant package of claim 11 wherein the decorative printed pattern of the laminated sheet of material is applied to the layer of waxy material.

19. The plant package of claim 18 wherein a lacquer is applied to a surface of the layer of waxy material of the laminated sheet of material prior to disposition of the decorative printed pattern thereon to prevent distortion of the decorative printed pattern.

20. The plant package of claim 18 wherein an ink containing a pigment and an effective amount of at least one anti-bleeding agent is utilized to apply the decorative printed pattern to the layer of waxy material of the laminated sheet of material to prevent distortion of the decorative printed pattern.

21. The laminated sheet of material of claim 20 wherein the anti-bleeding agent is selected from the group consisting of sodium silicate, sugar and starch.

22. A method for forming a decorative wrapper for a floral grouping wherein the decorative wrapper is constructed of a waxy material and has a decorative printed pattern disposed thereon, the method comprising the steps of:
providing a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the decorative wrapper formed from the laminated sheet of material;
providing a floral grouping having a bloom portion and a stem portion; and
wrapping the laminated sheet of material about the floral grouping to provide a decorative wrapper for the floral grouping such that the decorative wrapper substantially encompasses and surrounds a substantial portion of the floral grouping.

23. The method of claim 22 wherein, in the step of providing the laminated sheet of material, the laminated sheet of material is provided with a bonding material disposed thereon for securing the laminated sheet of material in a wrapped position about the floral grouping.

24. The method of claim 22 wherein, in the step of providing the laminated sheet of material, the support layer of material has a thickness in a range of from about 0.1 mil to about 30 mil and the layer of waxy material has a thickness in a range of from about 0.1 mil to about 30 mil.

25. The method of claim 22 wherein, in the step of providing the laminated sheet of material, the laminated sheet of material further comprises a second layer of waxy material connected or laminated to the unlaminated upper or lower surface of the support layer of material.

26. The method of claim 22 wherein, in the step of providing the laminated sheet of material, the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a translucent or transparent material such that the decorative printed pattern is visible through the layer of waxy material.

27. The method of claim 22 wherein, in the step of providing the laminated sheet of material, the support layer of material and the layer of waxy material are constructed from transparent or translucent materials.

28. The method of claim 27 wherein, in the step of providing the laminated sheet of material, the decorative printed pattern is applied to the unlaminated surface of the support layer of material, and the decorative printed pattern is visible through the layer of waxy material laminated to the other surface of the support layer of material.

29. The method of claim 22 wherein, in the step of providing the laminated sheet of material, the decorative printed pattern is applied to the layer of waxy material.

30. The method of claim 29 wherein, in the step of providing the laminated sheet of material, a lacquer is applied to a surface of the layer of waxy material prior to disposition of the decorative printed pattern thereon to prevent distortion of the decorative printed pattern.

31. The method of claim 29 wherein, in the step of providing the laminated sheet of material, an ink containing a pigment and an effective amount of at least one anti-bleeding agent is utilized to apply the decorative printed pattern to the layer of waxy material to prevent distortion of the decorative printed pattern.

32. The laminated sheet of material of claim 31 wherein the anti-bleeding agent is selected from the group consisting of sodium silicate, sugar and starch.

33. A method for forming a decorative wrapper for a flower pot wherein the decorative wrapper is formed of a waxy material having a decorative printed pattern disposed thereon, the method comprising the steps of:
providing a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the decorative wrapper formed from the laminated sheet of material;
providing a flower pot having an upper end, a lower end, an outer peripheral surface and an inner retaining space; and
wrapping the laminated sheet of material about the outer peripheral surface of the flower pot thereby providing a decorative wrapper for the flower pot.

34. The method of claim 33 wherein, in the step of providing the laminated sheet of material, the laminated sheet of material is provided with a bonding material disposed thereon for securing the laminated sheet of material in a wrapped position about the flower pot.

35. The method of claim 33 wherein, in the step of providing the laminated sheet of material, the support layer of material has a thickness in a range of from about 0.1 mil to about 30 mil and the layer of waxy material has a thickness in a range of from about 0.1 mil to about 30 mil.

36. The method of claim 33 wherein, in the step of providing the laminated sheet of material, the laminated sheet of material further comprises a second layer of waxy material connected or laminated to the unlaminated upper or lower surface of the support layer of material.

37. The method of claim 33 wherein, in the step of providing the laminated sheet of material, the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and the layer of waxy material is constructed from a transparent or translucent material such that the decorative printed pattern is visible through the layer of waxy material.

38. The method of claim 33 wherein, in the step of providing the laminated sheet of material, the support layer of material and the layer of waxy material are constructed from transparent or translucent materials.

39. The method of claim 38 wherein, in the step of providing the laminated sheet of material, the decorative printed pattern is applied to the unlaminated surface of the support layer of material, and the decorative printed pattern is visible through the layer of waxy material laminated to the other surface of the support layer of material.

40. The method of claim 33 wherein, in the step of providing the laminated sheet of material, the decorative printed pattern is applied to the layer of waxy material.

41. The method of claim 40 wherein, in the step of providing the laminated sheet of material, a lacquer is applied to a surface of the layer of waxy material prior to disposition of the decorative printed pattern thereon to prevent distortion of the decorative printed pattern.

42. The method of claim 40 wherein, in the step of providing the laminated sheet of material, an ink containing a pigment and an effective amount of at least one anti-bleeding agent is utilized to apply the decorative printed pattern to the layer of waxy material to prevent distortion of the decorative printed pattern.

43. The laminated sheet of material of claim 42 wherein the anti-bleeding agent is selected from the group consisting of sodium silicate, sugar and starch.

44. A decorative cover for a flower pot, the decorative cover being formed of a waxy material having a decorative printed pattern thereon, the decorative cover produced by the method comprising the steps of:
forming a laminated sheet of material about an outer peripheral surface of a flower pot to provide the decorative cover, the laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the decorative cover formed from the laminated sheet of material.

45. The decorative cover of claim 44 wherein the laminated sheet of material is provided with a bonding material disposed thereon for securing the laminated sheet of material in a wrapped position about the flower pot.

46. The decorative cover of claim 44 wherein the support layer of material has a thickness in a range of from about 0.1 mil to about 30 mil and the layer of waxy material has a thickness in a range of from about 0.1 mil to about 30 mil.

47. The decorative cover of claim 44 wherein the laminated sheet of material further comprises a second layer of waxy material connected or laminated to the unlaminated upper or lower surface of the support layer of material.

48. The decorative cover of claim 44 wherein the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

49. The decorative cover of claim 44 wherein the support layer of material and the layer of waxy material are constructed from transparent or translucent materials.

50. The decorative cover of claim 49 wherein the decorative printed pattern is applied to the unlaminated surface of the support layer of material, and the decorative printed pattern is visible through the layer of waxy material laminated to the other surface of the support layer of material.

51. The decorative cover of claim 44 wherein the decorative printed pattern is applied to the layer of waxy material.

52. The decorative cover of claim 51 wherein a lacquer is applied to a surface of the layer of waxy material prior to disposition of the decorative printed pattern thereon to prevent distortion of the decorative printed pattern.

53. The decorative cover of claim 51 wherein an ink containing a pigment and an effective amount of at least one anti-bleeding agent is utilized to apply the decorative printed pattern to the waxy material to prevent distortion of the decorative printed pattern.

54. The laminated sheet of material of claim 53 wherein the anti-bleeding agent is selected from the group consisting of sodium silicate, sugar and starch.

55. A method for forming a decorative cover for a floral grouping, the decorative cover formed from a waxy material and having a decorative printed pattern disposed thereon, the method comprising the steps of:
providing a sleeve having an upper end, a lower end, an outer peripheral surface and an inner retaining space, the sleeve constructed from a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the sleeve formed from the laminated sheet of material;
providing a floral grouping having a bloom portion and a stem portion; and
disposing the floral grouping in the inner retaining space of the sleeve such that the sleeve substantially surrounds and encompasses at least a portion of the floral grouping.

56. The method of claim 55 wherein, in the step of providing the sleeve, the laminated sheet of material is provided with a bonding material disposed thereon for securing the laminated sheet of material in a wrapped position about the floral grouping.

57. The method of claim 55 wherein, in the step of providing the sleeve, the support layer of material has a thickness in a range of from about 0.1 mil to about 30 mil and the layer of waxy material has a thickness in a range of from about 0.1 mil to about 30 mil.

58. The method of claim 55 wherein, in the step of providing the sleeve, the laminated sheet of material further comprises a second layer of waxy material connected or laminated to the unlaminated upper or lower surface of the support layer of material.

59. The method of claim 55 wherein, in the step of providing the sleeve, the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

60. The method of claim 55 wherein, in the step of providing the sleeve, the support layer of material and the layer of waxy material are constructed from transparent or translucent materials.

61. The method of claim 60 wherein, in the step of providing the sleeve, the decorative printed pattern is applied to the unlaminated surface of the support layer of material, and the decorative printed pattern is visible through the layer of waxy material laminated to the other surface of the support layer of material.

62. The method of claim 55 wherein, in the step of providing the sleeve, the decorative printed pattern is applied to the layer of waxy material.

63. The method of claim 62 wherein, in the step of providing the sleeve, a lacquer is applied to a surface of the layer of waxy material prior to disposition of the decorative printed pattern thereon to prevent distortion of the decorative printed pattern.

64. The method of claim 62 wherein, in the step of providing the sleeve, an ink containing a pigment and an effective amount of at least one anti-bleeding agent is utilized to apply the decorative printed pattern to the waxy material to prevent distortion of the decorative printed pattern.

65. The laminated sheet of material of claim 64 wherein the anti-bleeding agent is selected from the group consisting of sodium silicate, sugar and starch.

66. A decorative cover for a floral grouping, the decorative cover being formed from a sleeve having an upper end, a lower end, an outer peripheral surface and an inner retaining space, the sleeve constructed from a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the sleeve formed from the laminated sheet of material.

67. The decorative cover of claim 66 wherein the laminated sheet of material is provided with a bonding material disposed thereon for securing the laminated sheet of material in a wrapped position about the flower pot.

68. The decorative cover of claim 66 wherein the support layer of material has a thickness in a range of from about 0.1 mil to about 30 mil and the layer of waxy material has a thickness in a range of from about 0.1 mil to about 30 mil.

69. The decorative cover of claim 66 wherein the laminated sheet of material further comprises a second layer of waxy material connected or laminated to the unlaminated upper or lower surface of the support layer of material.

70. The decorative cover of claim 66 wherein the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

71. The decorative cover of claim 66 wherein the support layer of material and the layer of waxy material are constructed from transparent or translucent materials.

72. The decorative cover of claim 71 wherein the decorative printed pattern is applied to the unlaminated surface of the support layer of material, and the decorative printed pattern is visible through the layer of waxy material laminated to the other surface of the support layer of material.

73. The decorative cover of claim 66 wherein the decorative printed pattern is applied to the layer of waxy material.

74. The decorative cover of claim 73 wherein a lacquer is applied to a surface of the layer of waxy material prior to disposition of the decorative printed pattern thereon to prevent distortion of the decorative printed pattern.

75. The decorative cover of claim 73 wherein an ink containing a pigment and an effective amount of at least one anti-bleeding agent is utilized to apply the decorative printed pattern to the waxy material to prevent distortion of the decorative printed pattern.

76. The laminated sheet of material of claim 75 wherein the anti-bleeding agent is selected from the group consisting of sodium silicate, sugar and starch.

77. A method for forming a decorative flower pot cover formed of a waxy material and having a decorative printed pattern disposed thereon, the method comprising the steps of:
providing a sleeve having an upper end, a lower end, an outer peripheral surface and an inner retaining space, the sleeve comprising an upper portion and a lower portion wherein the upper portion of the sleeve is detachable from the lower portion of the sleeve via vertical perforations and circumferential perforations, the sleeve formed of a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of a decorative cover formed from the laminated sheet of material;
providing a flower pot having an upper end, a lower end, an outer peripheral surface and an inner retaining space, the flower pot having growing medium and a floral grouping or a plant disposed in the inner retaining space thereof; and
disposing the flower pot within the sleeve, whereby the lower portion of the sleeve is positioned substantially adjacent the outer peripheral surface of the flower pot and the upper portion of the sleeve extends upwardly from the flower pot and substantially surrounds and encompasses the floral grouping or plant disposed in the flower pot, the upper portion of the sleeve being detachable from the lower portion of the sleeve along the vertical and circumferential perforations such that upon detachment of the upper portion of the sleeve, the lower portion of the sleeve remains disposed about the outer peripheral surface of the flower pot, the lower portion comprising a base portion substantially adjacent to and surrounding the outer peripheral surface of the flower pot and a skirt portion which extends beyond the upper end of the flower pot and adjacent at least a portion of the plant contained within the flower pot.

78. The method of claim 77 wherein, in the step of providing the sleeve, the laminated sheet of material is provided with a bonding material disposed thereon for securing the laminated sheet of material in a wrapped position about the flower pot.

79. The method of claim 77 wherein, in the step of providing the sleeve, the support layer of material has a thickness in a range of from about 0.1 mil to about 30 mil and the layer of waxy material has a thickness in a range of from about 0.1 mil to about 30 mil.

80. The method of claim 77 wherein, in the step of providing the sleeve, the laminated sheet of material further comprises a second layer of waxy material connected or laminated to the unlaminated upper or lower surface of the support layer of material.

81. The method of claim 77 wherein, in the step of providing the sleeve, the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

82. The method of claim 77 wherein, in the step of providing the sleeve, the support layer of material and the layer of waxy material are constructed from transparent or translucent materials.

83. The method of claim 82 wherein, in the step of providing the sleeve, the decorative printed pattern is applied to the unlaminated surface of the support layer of material, and the decorative printed pattern is visible through the layer of waxy material laminated to the other surface of the support layer of material.

84. The method of claim 77 wherein, in the step of providing the sleeve, the decorative printed pattern is applied to the layer of waxy material.

85. The method of claim 84 wherein, in the step of providing the sleeve, a lacquer is applied to a surface of the layer of waxy material prior to disposition of the decorative printed pattern thereon to prevent distortion of the decorative printed pattern.

86. The method of claim 84 wherein, in the step of providing the sleeve, an ink containing a pigment and an effective amount of at least one anti-bleeding agent is utilized to apply the decorative printed pattern to the waxy material to prevent distortion of the decorative printed pattern.

87. The laminated sheet of material of claim 86 wherein the anti-bleeding agent is selected from the group consisting of sodium silicate, sugar and starch.

88. A decorative flower pot cover formed of a waxy material and having a decorative printed pattern disposed thereon, the decorative flower pot cover comprising:
a sleeve having an upper end, a lower end, an outer peripheral surface, and an inner retaining space, the sleeve comprising an upper portion and a lower portion wherein the lower portion of the sleeve is sized to closely surround and encompass a flower pot disposed therein and the upper portion extends upwardly from a flower pot disposed therein and substantially surrounds and encompasses a floral grouping or plant disposed in the flower pot, the upper portion of the sleeve being detachable from the lower portion of the sleeve via vertical perforations and circumferential perforations such that upon detachment of the upper portion of the sleeve, the lower portion of the sleeve remains disposed about the outer peripheral surface of the flower pot, thereby forming a decorative flower pot cover, the sleeve formed of a laminated sheet of material having an upper surface and a lower surface, the laminated sheet of material comprising:
a support layer of material having an upper surface and a lower surface and being constructed of paper, metal foil, polymeric film, fabric, cardboard, or laminations or combinations thereof;
a layer of waxy material which is connected or laminated to one of the upper and lower surfaces of the support layer of material; and
a decorative printed pattern visible on at least a portion of at least one of the upper and lower surfaces of the laminated sheet of material such that the decorative printed pattern is substantially undistorted and is visible on an exposed surface of the sleeve formed from the laminated sheet of material.

89. The decorative flower pot cover of claim 88 wherein the laminated sheet of material is provided with a bonding material disposed thereon for securing the laminated sheet of material in a wrapped position about the flower pot.

90. The decorative flower pot cover of claim 88 wherein the support layer of material has a thickness in a range of from about 0.1 mil to about 30 mil and the layer of waxy material has a thickness in a range of from about 0.1 mil to about 30 mil.

91. The decorative flower pot cover of claim 88 wherein the laminated sheet of material further comprises a second layer of waxy material connected or laminated to the unlaminated upper or lower surface of the support layer of material.

92. The decorative flower pot cover of claim 88 wherein the decorative printed pattern is applied to at least a portion of one of the upper and lower surfaces of the support layer of material prior to lamination of the layer of waxy material thereto, such that the decorative printed pattern is sandwiched in between the two layers, thereby preventing distortion thereof, and wherein the layer of waxy material is constructed of a transparent or translucent material such that the decorative printed pattern is visible through the layer of waxy material.

93. The decorative flower pot cover of claim 88 wherein the support layer of material and the layer of waxy material are constructed from transparent or translucent materials.

94. The decorative flower pot cover of claim 93 wherein the decorative printed pattern is applied to the unlaminated surface of the support layer of material, and the decorative printed pattern is visible through the layer of waxy material laminated to the other surface of the support layer of material.

95. The decorative flower pot cover of claim 88 wherein the decorative printed pattern is applied to the layer of waxy material.

96. The decorative flower pot cover of claim 95 wherein a lacquer is applied to a surface of the layer of waxy material prior to disposition of the decorative printed pattern thereon to prevent distortion of the decorative printed pattern.

97. The decorative flower pot cover of claim 95 wherein an ink containing a pigment and an effective amount of at least one anti-bleeding agent is utilized to apply the decorative printed pattern to the waxy material to prevent distortion of the decorative printed pattern.

98. The laminated sheet of material of claim 97 wherein the anti-bleeding agent is selected from the group consisting of sodium silicate, sugar and starch.
